(19) United States
(12) Patent Application Publication
(10) Pub. No.: US 2003/0195800 A1
(43) Pub. Date: Oct. 16, 2003

(54) System and method for smart UPC tag based advertising

(75) Inventor: Mark E. Peters, Chapel Hill, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 10/120,133

(22) Filed: Apr. 10, 2002

(51) Int. Cl. G06F 17/60

(52) U.S. Cl. 705/14; 705/20; 705/21

(57) ABSTRACT

A system and method is provided for marketing products to a customer when the customer is shopping. This invention contemplates reading the UPC tag of an item carried by a customer and marketing related items to the customer prior to checkout. Related items may be complementary, matching, prerequisite, or competitive items. The related items may be marketed to the customer by, e.g., displaying advertisements for the related items on screens located throughout the store, printing coupons for the related items, or storing electronic coupons for the related items onto a coupon card. Marketing related items to customers in this manner encourages customers to buy those items before leaving the store.

### BACKGROUND OF THE INVENTION

1. Technical Field

The present invention relates in general to a system and method for marketing products to customers. Still more particularly, the present invention relates to a system and method for advertising products and providing coupons to a customer when the customer is shopping by scanning the proximity readable UPC tags of the items already in the customer's possession.

2. Description of the Related Art

Computer systems have become increasingly integrated with people's day-to-day lives. For example, many people keep their calendars electronically on a computer system. Another example is sending notes electronically as email rather than using postal or courier services. Also, consumer banking has become more efficient with the introduction of computer technology. Consumers can now transfer money and pay bills electronically without having to write and deliver checks. Even telephone systems are increasingly computerized with computers interfacing with telephone systems and configuring the telephone according to the user's preferences. Telephone control may even reside in the user's personal computer.

Computer technology has also improved people's shopping experiences. Customers no longer have to wait in long checkout lines for store clerks to use calculators to add together the prices of all the items being purchased by a particular customer. Instead, the store clerks scan the Uniform Product Code (UPC) tag located on or attached to each item being purchased. A computer in communication with the detectable device retrieves the price of the item identified by the UPC tag, which is stored on the hard drive of the computer. The computer then calculates the total price owed by the customer after all the UPC tags of the items being purchased have been scanned.

After a customer has paid for his merchandise, e.g., groceries, the computer prints a receipt for the customer. It may also print coupons the customer can use in future visits to the store. The computer determines the type of coupons to print for each customer based upon the UPC tags of the items that have been purchased. These coupons influence the customer to purchase the same brands or competitive brands at a future date, and thereby benefit the consumer, the store, and the companies whose brands are being advertised. Unfortunately, the benefits provided by the coupons are delayed until the consumer decides to shop at the store again, which could be at a much later date. By that time, the customer may have forgotten that the coupons exist. Furthermore, the customer may misplace or lose the coupons before returning to the store again, rendering the coupons useless to everybody concerned.

What is needed, therefore, is a system and method for advertising products to a customer in a way that would influence the customer to buy the products before leaving the store. The customer would no longer need to keep track of coupons between visits to the store. Consequently, the customer, the store, and the manufacturers of the advertised products would immediately benefit from such advertising rather than having to wait until the customer possibly buys the advertised products at a later date.

### SUMMARY

A system and method has been developed for marketing products to a customer while the customer is shopping. This invention contemplates reading the UPC tag of an item carried by a customer and marketing one or more related items to the customer prior to checkout. The term “related item” is herein defined to mean any item related in some way to an item carried by a customer, e.g., a complementary, matching, pre-requisite, or competitive item. Therefore, marketing in this context includes cross-selling complementary, matching, and pre-requisite items. It also includes up-selling more expensive items that provide the merchant with a greater profit margin.

The related items may be marketed to the customer by, e.g., printing coupons for the related items, storing electronic coupons for the related items onto customer storage media known as “coupon cards”, or communicating advertisements for the related items to the customer using video, audio, or some other proximity communication means, such as messaging to a customer wireless device. For example, a customer carrying a toy car might pass by a screen that says “That toy car requires 4 D size batteries.” If the customer still doesn't have the batteries at checkout, the system could remind the customer to purchase the batteries as he waits in line. It could also indicate to the checkout clerk that the customer needs batteries, and the clerk could instruct the bagging person to get the batteries while the clerk rings up the other items. In addition, the customer could be alerted to items, such as batteries that he needs when he passes the area of the store where the items are located. In this manner, when the customer is approaching the battery section of the store a message could be displayed reminding him to purchase the necessary batteries.

Marketing related items to customers in this manner encourages customers to buy those items before leaving the store. It also ensures that customers do not leave the store without considering all their product choices. Furthermore, it allows customers to save money on the products they are buying now rather than falsely assuming they will save money on products purchased in the future. Moreover, the store's owner and the companies whose brands are being marketed benefit financially from the increased number of items presently sold.

In an embodiment of the invention, a system and method is provided for marketing products to a customer as the customer shops. First, the UPC tag of an item carried by the customer is read when located proximate a UPC detectable device. A related item is then retrieved from a database and marketed to the customer before the customer reaches checkout. The related item may be marketed by displaying its sale price or an advertisement for the item on a screen positioned near the customer. Multiple related items can be displayed in this manner. Alternatively, coupons for the related items may be printed or stored onto a coupon card. Kiosks and screens with UPC detectable devices may be located throughout the store for marketing the related items. As the customer picks up items he intends to purchase, the items are scanned so that related items may be advertised to the customer.

Another example of advertising related items includes prompting the customer to provide his identification to the kiosk. Alternatively, the customer may be prompted to insert an ID/coupon card into the kiosk. The customer's rating may be retrieved from a database, and one or more coupons for the related items may be displayed on a touch-screen. These coupons provide discounts to the customer based on the customer's rating. For example, customers with an excellent rating are rewarded with the maximum discount prices, whereas customers with the weakest rating receive the minimum discount prices. Subsequent to displaying the coupons for the various related items, the customer is prompted to select which coupons he would like to use. The kiosk then prints the selected coupons, or in the case where an ID/coupon card is used, it stores electronic coupons to the card. The coupons or ID/coupon card may be presented at checkout to receive discounts for the related items that the customer wants to purchase.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view showing the inside of a grocery store having screens and kiosks for marketing items to customers that are related to the items the customers have already placed in their shopping carts;

FIG. 2 is a side plan view of an aisle in the grocery store shown in FIG. 1;

FIG. 3 is a flowchart showing the steps involved in advertising items to a customer on a screen in a store by scanning the proximity-readable UPC tags of the items in the customer's shopping cart, thereby influencing the customer to buy certain items before leaving the store;

FIG. 4 is a flowchart illustrating the steps involved in printing coupons for a customer by scanning the proximity-readable UPC tags of the items in the customer's shopping cart, thereby influencing the customer to buy certain items before leaving the store;

FIG. 5 is a flowchart illustrating the steps involved in storing coupons to a customer's ID/coupon card by scanning the proximity-readable UPC tags of the items in the customer's shopping cart, thereby influencing the customer to buy certain items before leaving the store;

FIG. 6 is a flowchart showing the steps involved in using an ID/coupon card at checkout to receive cost savings on the items being purchased; and

FIG. 7 is a block diagram of a pervasive computing device capable of implementing the method for marketing products to a customer shopping in a store.

### DETAILED DESCRIPTION

The following is intended to provide a detailed description of an example of the invention and should not be taken to be limiting of the invention itself. Rather, any number of variations may fall within the scope of the invention, which is defined in the claims following the description.

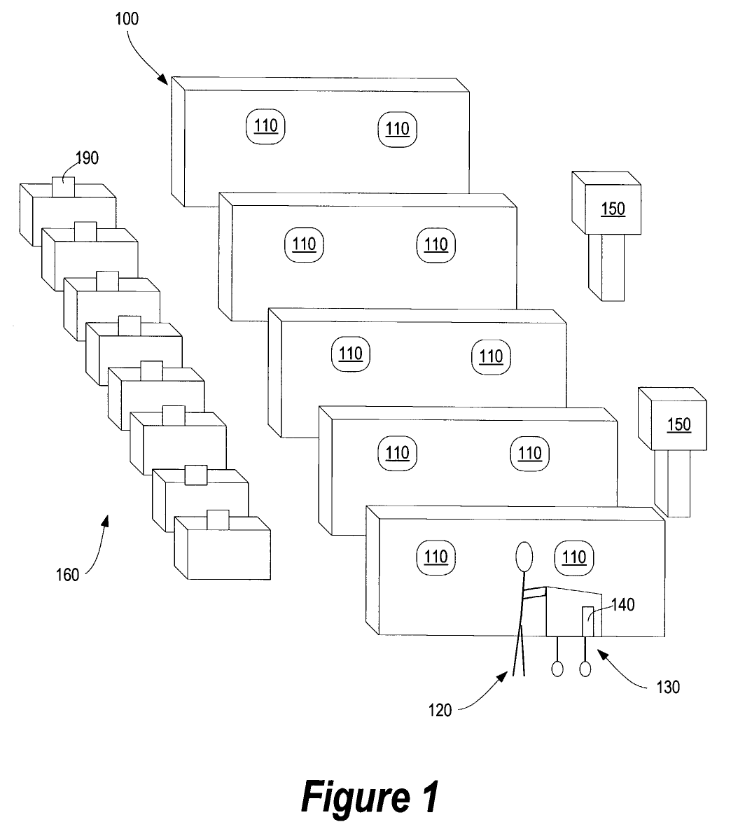

FIG. 1 depicts a perspective view of a grocery store in which the invention hereof has been implemented. It is to be understood that the invention may be used in any type of store and is not limited to grocery stores. As shown, the store contains several rows of storage shelves 100 that hold the items being sold in the store. Display screens 110 are positioned along the rows of storage shelves 100 for advertising items to customers as they shop. Display screens 110 may be capable of printing tangible coupons and/or saving electronic coupons to a coupon card. Display screens 110 are not limited to the shown locations and may be located anywhere in the store that can be viewed by customers. For example, they may be located near the checkout lines in the store so that they may be viewed while customers wait in line.

An exemplary customer 120 pushes a shopping cart 130 around the store. Customer 120 places the items he intends to purchase, such as item 140 in shopping cart 130. A proximity-readable UPC tag is located on or attached to each item being sold in the store, and detectable devices are located throughout the store. An example of a proximity-readable UPC tag that may be used to implement the invention is the so-called “radio frequency identification (RFID) tag,” which can communicate with a networked detection system to track items placed in a shopping cart. One type of RFID tag, the inductively coupled RFID tag, comprises a silicon microprocessor chip, a metal coil antenna that is wound into a circular pattern, and an encapsulating material, such as a glass or polymer material that surrounds the chip and coil. A detecting device (i.e., reader) generates a magnetic filed to power the inductive RFID tag. The tag modulates the magnetic field, thereby transmitting data back to the detecting device, which directs the data to a host computer. The size of the coil antenna dictates the detectable distance of the tag.

As customer 120 shops, the UPC tag of item 140 is scanned whenever it passes within the detectable range of one of the detectable devices located throughout the store. Related items of item 140 are then retrieved from a database and advertised on the display screen 110 closest to customer 120.

Kiosks 150 that provide coupons to customers may also be positioned around the store at any locations accessible to customers. Kiosks 150 are capable of printing coupons for items that complement or compete with the items already selected by a customer. Alternatively, kiosks 150 are capable of storing electronic coupons on coupon cards. Kiosks 150 also have display screens for communicating with customers. When customer 120 approaches one of the kiosks 150, a detectable device in communication with kiosk 150 detects the proximity-readable UPC tag of item 140. The kiosk 150 retrieves related items of item 140 and then displays coupons for the related items on its screen. Customer 120 can then select which coupons he would like to have printed or stored to his coupon card. These coupons influence customer 120 to buy certain items before leaving the store.

FIG. 1 further depicts checkout counters 160, which are positioned near the front of the grocery store. When customer 120 has finished shopping, he can purchase the items he has picked up in the store at one of the checkout counters 160. Customer 120 may present any coupons he received from kiosk 150 at this time. A card reader 190 that is capable of reading electronic coupons stored on a coupon card may be attached to each checkout counter 160. As such, customer 120 may slide a coupon card through card reader 190 to obtain any discounts stored to the coupon card by kiosk 150.

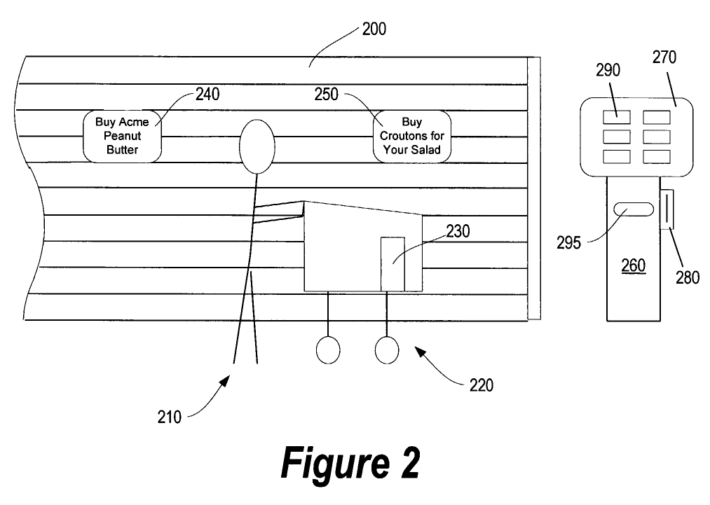

FIG. 2 depicts a side plan view of an exemplary aisle of the grocery store shown in FIG. 1. As customer 210 adds more items 230 to his shopping cart 220, display screens 240 and 250 advertise related items to customer 210. More specifically, the proximity-readable UPC tags of items 230 are scanned so that related items may be retrieved from a database and advertised to customer 210. If, for example, customer 210 places one brand of peanut butter in shopping cart 220, another brand of peanut butter may be advertised, as shown on screen 240. The other brand of peanut butter could be, e.g., a more upscale brand whose sale would bring in a higher margin of profit for the store. A product that complements one of the items 230 might also be advertised. For example, screen 250 advertises croutons, which would complement a salad placed in shopping cart 220 by customer 210.

When customer 220 pushes items 230 to within a detectable range of kiosk 260, the UPC tags of items 230 are scanned. The related items with respect to items 230 are retrieved from a database, and coupons for the related items may be displayed on touch-screen 270, which detects the contact of a human or an object. Customer 210 may select the coupons he wants to use by lightly tapping the appropriate area 290 of touch-screen 270. Kiosk 260 is capable of printing the coupons and distributing them to customer 210 through opening 295. Kiosk 260 also includes a reading device 280 for receiving coupon cards from customers and reading the data stored on the cards. For example, customer 220 may insert a coupon card into reader 280, and the coupons he selects may be stored to the card for later use at checkout.

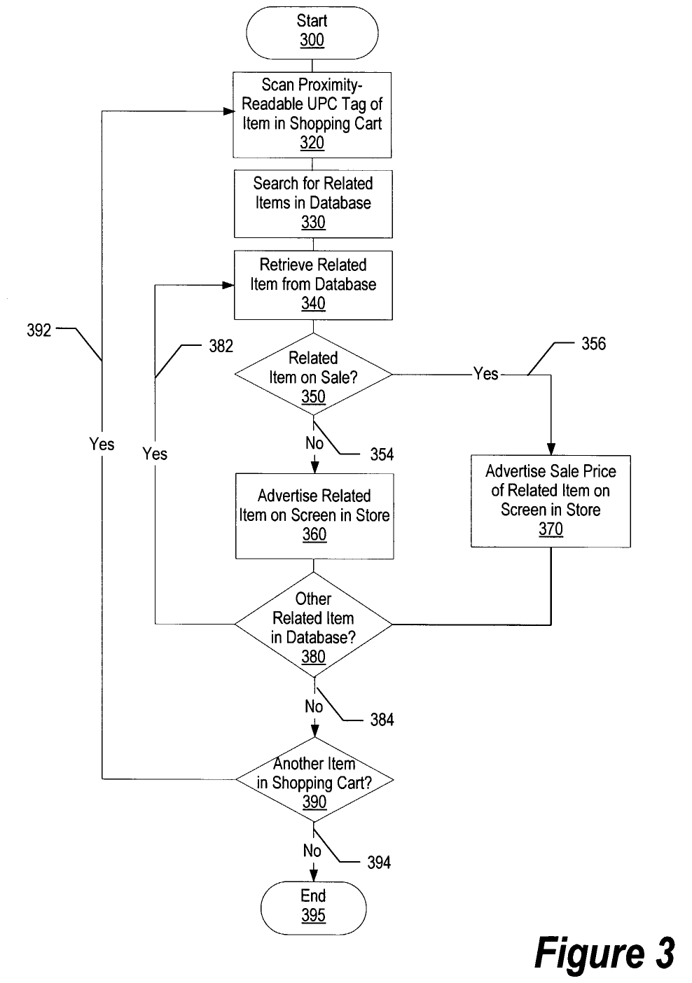

Turning to FIG. 3, a flowchart illustrates an embodiment of the invention in which items that are related to other items a customer intends to buy are advertised to the customer as he shops. Advertising related items commences at 300 whereupon a proximity-readable UPC tag of an item in a customer's shopping cart is scanned (step 320). For this step to occur, the customer must move the item to within a detectable range of a UPC tag detectable device. It is contemplated that other means for carrying the item may be used besides the shopping cart. Subsequent to scanning the UPC tag, a database is searched for related items of the scanned item (step 330). When a related item is found, it is retrieved from the database (step 340). A determination is then made as to whether the related item is on sale (decision 350). If the related item is not on sale, decision 350 branches to “no” branch 354, and the item is advertised on the display screen (step 360). In the case where the related item is on sale, decision 350 branches to “yes” branch 356. The item's sale price is advertised on a display screen located near the customer (step 370). It is contemplated that the display screen may be replaced with other forms of communication means, such as an audio system or a system for sending messages to the customer's wireless device.

Safety or educational information pertaining to the item carried by the customer or to the related item might also be retrieved from a database. This information could then be communicated to the customer using the display screen or some other communication means. For example, if the scanned item is a chainsaw, the display screen could provide the following safety considerations: “Make sure your chain doesn't touch the ground. Test your kickback guard. Keep the blades sharp. Don't forget your safety goggles, chain oil, and gas additive.” Referring to related items of the chainsaw in this manner provides the customer with an incentive to buy the related items for safety reasons. Therefore, communicating safety and educational information about an item to the customer may act as a marketing tool.

Next, it is determined whether another related item has been found in the database (decision 380). If the system has found another related item in the database, decision 380 branches to “yes” branch 382. The second related item is thereafter retrieved from the database (step 340), and the rest of the process is repeated up to the point where it is determined whether yet another related item has been found (decision 380). If the system has not found another related item in the database, decision 380 branches to “no” branch 384. A determination is then made as to whether another item is located in the shopping cart (decision 390). If another item is detected in the shopping cart, decision 390 branches to “yes” branch 392 whereupon the UPC tag of the next item is scanned (step 320). The entire process is then repeated up to decision 390. If, on the other hand, the shopping cart contains no other items, decision 390 branches to “no” branch 394, and processing ends at 395.

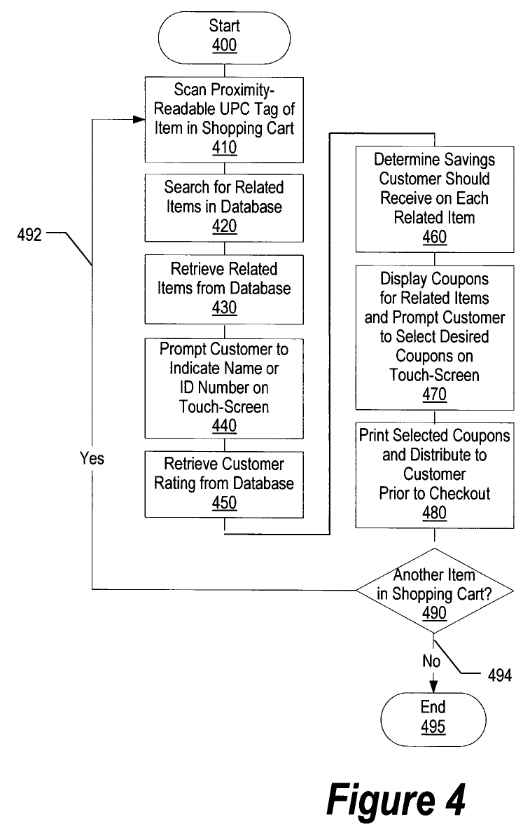

FIG. 4 depicts an embodiment of the invention in which coupons are printed by a kiosk for a customer prior to checkout based upon the items already in the customer's possession. Processing commences at 400 whereupon the proximity-readable UPC tag of an item carried by the customer is scanned when the item is within a detectable range of a detectable device (step 410). A database is then searched for related items, such as complementary items or competing items of the scanned item (step 420). After all the related items have been found, they are retrieved from the database (step 430). Subsequently, the customer is prompted to provide some form of identification, such as a name or ID number to the kiosk by using the kiosk's touch-screen (step 440). The customer's rating may then be retrieved from the database (step 450), followed by determining the savings the customer should receive on each related item based on the customer's rating (step 460). For example, if the customer is rated 5 on a scale of 1 to 5, he will receive the maximum available discount for each item. On the other hand, if the customer is rated 1, he will receive the minimum available discount for each item. The discount for a customer rating between 1 and 5 would be determined on a proportionate basis.

Coupons showing the discounts for the related items are subsequently displayed on a touch-screen, and the customer is prompted to select the coupons he wants to use (step 470). These selected coupons are then printed on, e.g., paper, and distributed to the customer, thereby influencing the customer to buy the related items before leaving the store (step 480). Next, a determination is made as to whether another item is disposed within the customer's shopping cart (decision 490). If this is the case, decision 490 branches to “yes” branch 492, and the process starting at scanning the UPC tag of the item (step 410) is repeated. However, if no other items are detected in the shopping cart, decision 490 branches to “no” branch 494. Processing ends at 495.

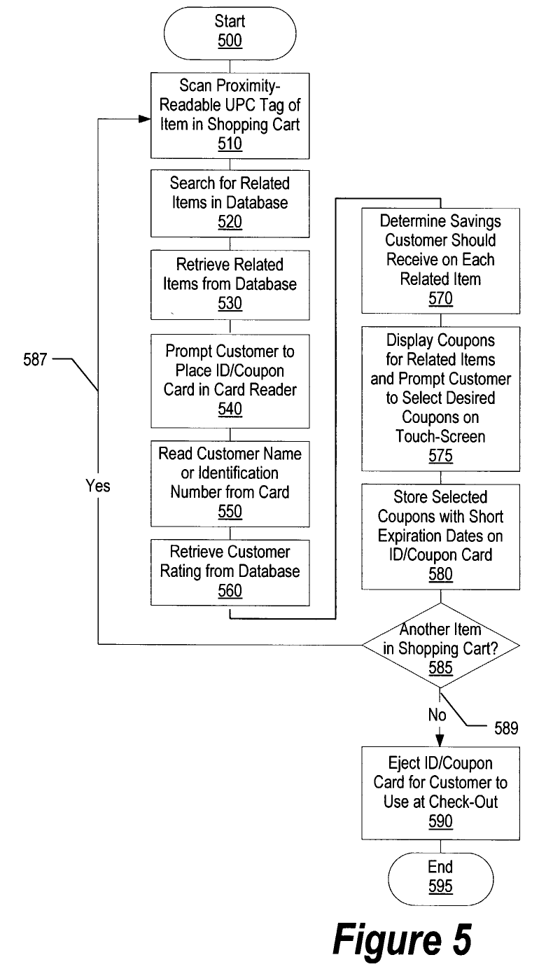

FIG. 5 depicts an alternative embodiment of the invention in which coupons are stored onto the customer's ID/coupon card rather than being printed out individually. Processing commences at 500 whereupon the proximity-readable UPC tag of a first item carried by the customer is scanned (step 510). The system searches a database for related items of the first item (step 520), followed by prompting the customer to place an ID/coupon card in a card reader (step 540). A form of identification, such as the customer's name or identification number is then read from the customer's ID/coupon card (step 550). Subsequently, the customer's rating is retrieved from a database (step 560), and the savings the customer should receive on each related item are determined in the manner described for FIG. 4 (step 570).

Coupons for the related items are then displayed on a touch-screen to allow the customer to select the coupons he desires (step 575). The coupons selected by the customer are stored to the ID/coupon card (step 580). These electronic coupons may be given relatively short expiration dates to encourage the customer to buy the related items as soon as possible, preferably before the customer leaves the store. Next, a determination is made as to whether another item is located in the customer's shopping cart (decision 585). If any other items are present in the shopping cart, decision 585 branches to “yes” branch 587 whereupon the next item's UPC tag is scanned. The entire process is then repeated up to decision 585. On the other hand, if the shopping cart contains no more items, decision 585 branches to “no” branch 589 whereupon the ID/coupon card is ejected for use by the customer at checkout (step 590). Processing thereafter ends at 595.

It is contemplated that the system could store the coupons selected by the customer in a database so that the discounts could be retrieved at checkout. As a result, the coupons would not have to be printed or saved on a coupon card. Instead, the discounts received by the customer would be reflected on the customer's receipt.

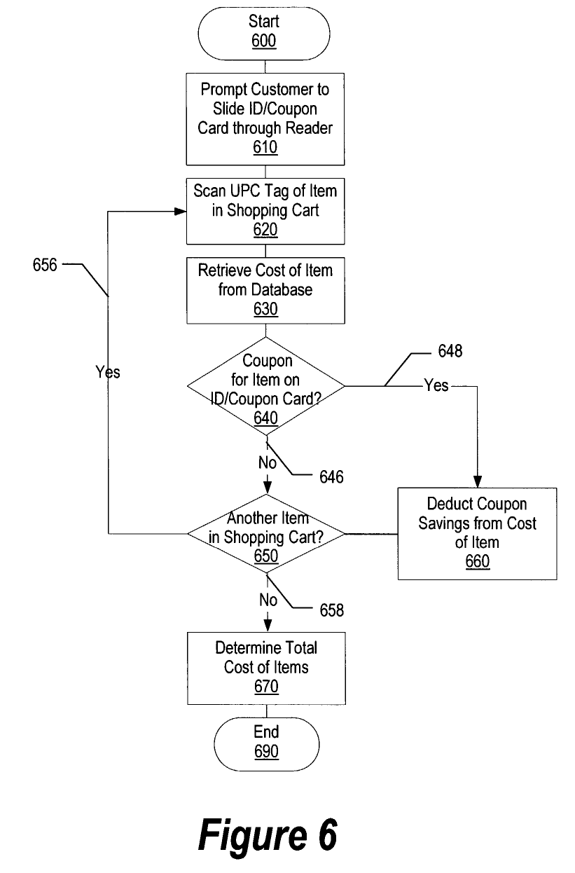

Turning to FIG. 6, a flowchart is shown for using the ID/coupon card described above at checkout to receive discounts for items being purchased. When the customer reaches the point where he pays for the items in his shopping cart, the checkout process commences at 600. First, the customer is prompted to slide his ID/coupon card through a card reader (step 610). The store clerk may then scan the UPC tag of an item being purchased by the customer (630), and the cost of that item may be retrieved from a database (step 630). It is then determined whether an electronic coupon for the item is stored on the ID/coupon card (decision 640). If the ID/coupon card does not contain an electronic coupon for the item, decision 640 branches to “no” branch 646 whereupon a determination is made as to whether another item is present in the customer's shopping cart (decision 650). However, if an electronic coupon for the item is stored on the card, the coupon savings are deducted from the cost of the item (step 660), followed by decision 650.

Turning to decision 650, if another item is located in the shopping cart, decision 650 branches to “yes” branch 656 whereupon the UPC tag of the next item in the shopping cart is scanned (step 620). The process is then repeated up to decision 650. If, on the other hand, no more items are detected in the shopping cart, decision 650 branches to “no” branch 658 whereupon the total cost of the items is calculated (step 670). Processing thereafter ends at 690.

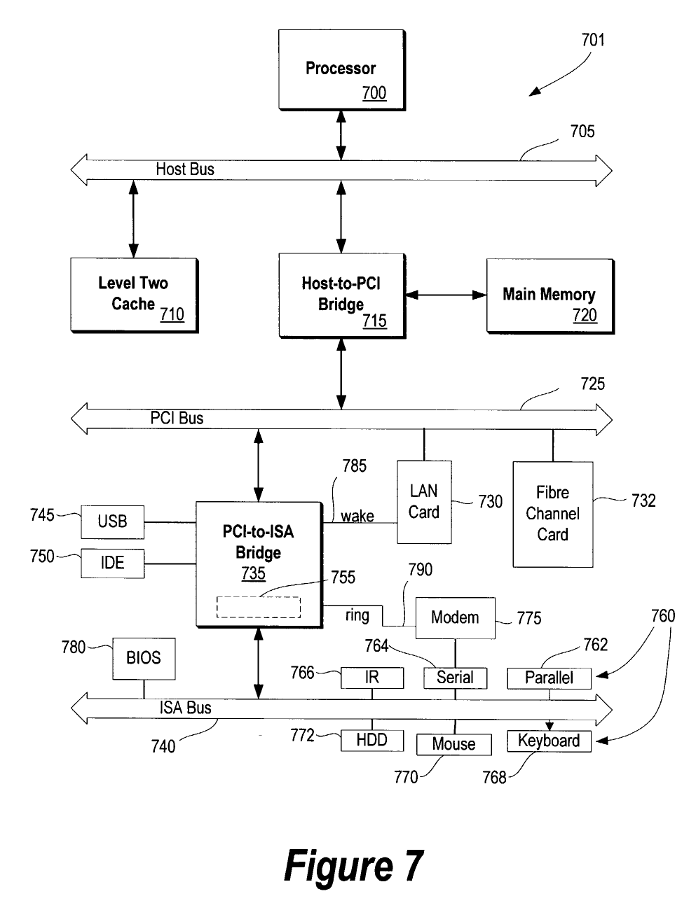

FIG. 7 illustrates information handling system 701, which is a simplified example of a computer system capable of implementing the invention described herein. Computer system 701 includes processor 700, which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices may be attached to various interfaces 760 (e.g., parallel interface 762, serial interface 764, infrared (IR) interface 766, keyboard interface 768, mouse interface 770, and fixed disk (FDD) 772 coupled to ISA bus 740. Alternatively, many I/O devices can be accommodated by a super I/O controller (not shown) attached to ISA bus 740.

BIOS 780 is coupled to ISA bus 740 and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 another computer system to copy files over a network, LAN card 730 is coupled to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the marketing processes described herein, this computer system is simply one example of a computer system. Those skilled in the art will appreciate that many other computer system designs are capable of performing the copying process described herein.

One of the preferred implementations of the invention is a client application, namely, a set of instructions (program code) in a code module, which may, for example, be resident in the random access memory of the computer. Until required by the computer, the set of instructions may be stored in another computer memory, for example, in a hard disk drive, or in a removable memory, such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for marketing products to a customer when the customer is shopping, said method comprising:
reading a readable tag of an item that has been selected by the customer, the item being located within a detectable range of a detecting device;
retrieving a record for a related item from a database; and
marketing the related item to the customer while the customer is shopping.

2. The method of claim 1, wherein the retrieving further comprises:
determining one or more complementary items based upon the item selected by the customer; and
communicating the complementary items to the customer using audio or video means.

3. The method of claim 1, wherein the retrieving further comprises:
determining one or more competing items based upon the item selected by the customer; and
communicating the related item to the customer using audio or video means.

4. The method of claim 1, wherein the marketing comprises:
detecting that the customer is approaching a display selected from a group of one or more displays; and
displaying information regarding the related item on the display.

5. The method of claim 1, further comprising:
reading an identifier corresponding to the customer;
retrieving a customer shopping history based on the identifier; and
determining the related item based on the customer shopping history.

6. The method of claim 1, wherein the marketing further comprises:
creating a coupon for the related item; and
distributing the coupon to the customer for use when purchasing the related item.

7. The method of claim 6, wherein the distributing further comprises:
transferring the coupon to a customer storage medium.

8. The method of claim 1, further comprising:
displaying safety and educational information corresponding to the item on a display device.

9. A method for marketing products to a customer when the customer is shopping, comprising:
reading a readable tag of an item that has been selected by the customer, the item being located within a detectable range of a detecting device;
retrieving a record for a related item from a database;
marketing the related item to the customer while the customer is shopping, wherein the marketing includes:
creating a coupon for the related item; and
distributing the coupon to the customer for use when purchasing the related item.

10. A method for marketing products to a customer when the customer is shopping, said method comprising:
reading a readable tag of an item that has been selected by the customer, the item being located within a detectable range of a detecting device;
reading an identifier corresponding to the customer;
retrieving a customer shopping history based on the identifier;
identifying a related item based on the customer shopping history and the item selected by the user;
retrieving a record for the related item from a database; and
marketing the related item to the customer while the customer is shopping.

11. An information handling system comprising:
one or more processors;
a memory accessible by the processors;
a nonvolatile storage device accessible by the processors;
a database of item records stored on the nonvolatile storage device;
a proximity tag reader accessible by the processors;
one or more displays; and
a marketing tool for advertising products to a customer when the customer is shopping, the marketing tool including:
detection logic for reading a proximity tag of an item that has been selected by the customer, the item being located within a detectable range of the proximity tag reader;
retrieval logic for retrieving a record for a related item from the database;
sensing logic for sensing the customer approaching one of the displays; and
display logic for displaying marketing information corresponding to the related item on the approached display.

12. The information handling system of claim 11, wherein the marketing tool further includes:
creation logic for creating a coupon for the related item; and
distribution logic for distributing the coupon to the customer for use when purchasing the related item.

13. The information handling system of claim 12, further comprising:
transmission logic for sending the coupon to a customer's wireless device;
receiving logic for receiving the coupon in a wireless signal from the customer's wireless device; and
redemption logic for redeeming the coupon prior to the customer purchasing the related item.

14. An information handling system comprising:
one or more processors;
a memory accessible by the processors;
a nonvolatile storage device accessible by the processors;
a database of item records stored on the nonvolatile storage device;
a proximity tag reader accessible by the processors; one or more displays; and
a marketing tool for advertising products to a customer when the customer is shopping, the marketing tool including:
detection logic for reading a proximity tag of an item that has been selected by the customer, the item being located within a detectable range of the proximity tag reader;
retrieval logic for retrieving a record for a related item from the database;
display logic for displaying marketing information corresponding to the related item on at lease one of the displays
creation logic for creating a coupon for the related item;
distribution logic for distributing the coupon to the customer for use when purchasing the related item; and
redemption logic for redeeming the coupon prior to the customer purchasing the related item

15. A computer program product stored on a computer operable medium for marketing products to a customer when the customer is shopping, said computer program product comprising:
means for reading a readable tag of an item that has been selected by the customer, the item being located within a detectable range of a detecting device;
means for retrieving a record for a related item from a database; and
means for marketing the related item to the customer while the customer is shopping.

16. The computer program product of claim 15, wherein the means for retrieving further comprises:
means for determining one or more complementary items based upon the item selected by the customer; and
means for communicating the complementary items to the customer using audio or video means.

17. The computer program product of claim 15, wherein the means for retrieving further comprises:
means for determining one or more competing items based upon the item selected by the customer; and
means for communicating the related item to the customer using audio or video means.

18. The computer program product of claim 15, wherein the means for marketing comprises:
means for displaying information regarding the related item on one or more displays located in a store as the customer approaches the displays.

19. The computer program product of claim 15, further comprising:
means for reading an identifier corresponding to the customer;
means for retrieving a customer shopping history based on the identifier; and
means for determining the related item based on the customer shopping history.

20. The computer program product of claim 15, wherein the means for marketing further comprises:
means for creating a coupon for the related item; and
means for distributing the coupon to the customer for use when purchasing the related item.

21. The computer program product of claim 20, wherein the means for distributing further comprises:
means for transferring the coupon to a customer storage medium.

22. The computer program product of claim 15, further comprising:
means for displaying safety and educational information corresponding to the item on a display device.

23. A computer program product for marketing products to a customer when the customer is shopping, comprising:
means for reading a readable tag of an item that has been selected by the customer, the item being located within a detectable range of a detecting device;
means for retrieving a record for a related item from a database;
means for marketing the related item to the customer while the customer is shopping, wherein the marketing includes:
creating a coupon for the related item; and
distributing the coupon to the customer for use when purchasing the related item.

24. A computer program product for marketing products to a customer when the customer is shopping, said computer program product comprising:
means for reading a readable tag of an item that has been selected by the customer, the item being located within a detectable range of a detecting device;
means for reading an identifier corresponding to the customer;
means for retrieving a customer shopping history based on the identifier;
means for identifying a related item based on the customer shopping history and the item selected by the user;
means for retrieving a record for the related item from a database; and
means for marketing the related item to the customer while the customer is shopping.
